(19) United States
(12) Patent Application Publication
(10) Pub. No.: US 2004/0189087 A1
(43) Pub. Date: Sep. 30, 2004

(54) Vehicle hydraulic brake device

(76) Inventor: Akihito Kusano, Kariya (JP)

Correspondence Address: BURNS DOANE SWECKER & MATHIS L L P, POST OFFICE BOX 1404, ALEXANDRIA, VA, 22313-1404, US

(21) Appl. No.: 10/808,471

(22) Filed: Mar. 25, 2004

(30) Foreign Application Priority Data
Mar. 28, 2003 (JP) 2003-090418

(51) Int. Cl. B60T 8/44

(52) U.S. Cl. 303/114.1

(57) ABSTRACT

In a hydraulic brake device for a vehicle in which the output hydraulic pressure of a hydraulic pressure source is adjusted to a value corresponding to the brake operating amount with a pressure adjusting valve and the master cylinder is actuated under the adjusted hydraulic pressure, bottoming may occur in which the master piston makes a full stroke while the braking force is still low due to a vapor lock phenomenon. In the hydraulic brake device of this invention, the hydraulic pressure generated in a hydraulic pressure source is adjusted to a value corresponding to the brake operating amount with a pressure adjusting valve and introduced into a pressure chamber to actuate the master piston of the master cylinder. A pressure sensor for detecting the output hydraulic pressure of the pressure adjusting valve and a master cylinder pressure sensor for detecting the output hydraulic pressure of the master cylinder are provided and the hydraulic pressures detected by both sensors are compared with each other by a bottoming detecting means to determine that bottoming of the master piston has occurred if the output hydraulic pressure of the master cylinder is smaller than a predetermined target value and, an alarm means gives an alarm.

### BACKGROUND OF THE INVENTION

This invention relates to a vehicle hydraulic brake device, specifically a vehicle hydraulic brake device which can detect a phenomenon (bottoming) in which a master piston of a master cylinder makes a full stroke before a sufficient braking force is obtained due to e.g. vapor lock phenomenon without incurring complexity of the structure.

JP patent publication 61-37140 discloses a hydraulic brake device for a vehicle including a hydraulic pressure source having a power-driven pump for generating a predetermined hydraulic pressure, a pressure adjusting valve for adjusting the output hydraulic pressure of the hydraulic pressure source to a value proportional to the brake operating amount, and a master cylinder having a master piston actuated under the output hydraulic pressure of the pressure adjusting valve, which is introduced into a pressure chamber, whereby the wheel cylinders are actuated under the output hydraulic pressure from the master cylinder to impart braking force to the wheels of the vehicle.

In a vehicle hydraulic brake device having a master cylinder, if vapor lock phenomenon occurs due e.g. to frequent brakings, there is a possibility that the master piston may make a full stroke while the braking force obtained is still low. If such a situation occurs, even if the brake is stepped on further, braking force will not increase any further.

In a vehicle hydraulic brake device in which the master cylinder is actuated under the output hydraulic pressure of the pressure adjusting valve, the driver may not notice this fact. Thus safety problems may arise. Thus, the device of JP patent publication 61-37140 has a means for detecting the stroke of the master piston. But since it is necessary to provide such a detecting means directly on the master cylinder and the structure is complicated, limitation may be put on the installation space in the vehicle, or the brake device may be expensive.

An object of this invention is to detect the bottoming of the master piston with a simple structure.

### SUMMARY OF THE INVENTION

According to this invention, there is provided a vehicle hydraulic brake device comprising a hydraulic pressure source for generating a predetermined hydraulic pressure, a pressure adjusting valve for adjusting the output hydraulic pressure of the hydraulic pressure source to a value proportional to a brake operating amount, a pressure chamber, a master cylinder having a master piston actuated under the output hydraulic pressure of the pressure adjusting valve introduced into the pressure chamber for generating brake hydraulic pressure, and wheel cylinders actuated under the output hydraulic pressure from the master cylinder for generating braking force to wheels of the vehicle, further comprising a brake operating amount detecting means for detecting the brake operating amount, a master cylinder pressure detecting means for detecting the output hydraulic pressure of the master cylinder, and a bottoming detecting means for detecting the bottoming of the master piston by comparing the brake operating amount detected by the brake operating amount detecting means with the output hydraulic pressure of the master cylinder detected by the master cylinder pressure detecting means.

The brake operating amount detected by the brake operating amount detecting means is not limited to the stroke of a brake operating member or the brake operating force applied to the brake operating member. It may be other information relevant to the brake operating amount such as the output hydraulic pressure of the pressure adjusting valve.

If the device to which this invention is applied is a vehicle hydraulic brake device comprising a hydraulic pressure source for generating a predetermined hydraulic pressure, a pressure adjusting valve for adjusting the output hydraulic pressure of the hydraulic pressure source to a value proportional to a brake operating amount, a pressure chamber, a tandem master cylinder having a first master piston actuated under the output hydraulic pressure of the pressure adjusting valve introduced into the pressure chamber to generate a first brake hydraulic pressure, and having a second master piston actuated under the first brake hydraulic pressure to generate a second brake hydraulic pressure, and wheel cylinders actuated under the first brake hydraulic pressure and the second brake hydraulic pressure for imparting braking force to wheels of the vehicle, it may be structured such that the first master piston and the second master piston have different effective diameters, and may further comprise a brake operating amount detecting means for detecting the brake operating amount, a master cylinder pressure detecting means for detecting the second brake hydraulic pressure generated by the tandem master cylinder, and a bottoming detecting means for detecting the bottoming of the first master piston or the second master piston by comparing the brake operating amount detected by the brake operating amount detecting means with the second brake hydraulic pressure detected by the master cylinder pressure detecting means.

Otherwise, it may further comprise a first master cylinder pressure detecting means and a second master cylinder pressure detecting means for detecting the first brake hydraulic pressure and the second brake hydraulic pressure, respectively, which the tandem master cylinder outputs, and a bottoming detecting means for detecting the bottoming of the first master piston or the second master piston by comparing the first brake hydraulic pressure detected by the first master cylinder pressure detecting means with the second brake hydraulic pressure detected by the second master cylinder pressure detecting means.

In any of the vehicle hydraulic brake devices, the bottoming detecting means preferably includes an alarm means for producing an alarm if the bottoming of the master piston is detected.

The vehicle hydraulic brake device of this invention can detect bottoming of the master piston and notify the driver of the fact, so that the driver can stop the vehicle before the braking force drops.

Also, since detection of the bottoming of the master piston is carried out by comparing the brake operating amount with the output hydraulic pressure of the master cylinder, or comparing the first brake hydraulic pressure generated in the tandem master cylinder with the second brake hydraulic pressure, it is not necessary to directly detect the stroke of the master piston. Thus the limitation of installation from the viewpoint of space is relaxed and also the cost increase of the vehicle hydraulic brake device is suppressed.

### BRIEF DESCRIPTION OF THE DRAWINGS

Other features and objects of the present invention will become apparent from the following description made with reference to the accompanying drawings, in which:

FIG. 1 is a view showing the first embodiment of the vehicle hydraulic brake device of this invention;

FIG. 2 is a view showing the second embodiment;

FIG. 3 is a view showing the third embodiment;

FIG. 4 is a view showing the fourth embodiment;

FIG. 5 is a flowchart for bottoming detection in the vehicle hydraulic brake devices of FIGS. 1 and 2;

FIG. 6 is a flowchart of bottoming detection in the vehicle hydraulic brake device of FIG. 3;

FIG. 7 is a flowchart of bottoming detection in the vehicle hydraulic brake device of FIG. 4;

FIG. 8A is a graph showing change in the relation between the output hydraulic pressure of the pressure adjusting valve and the second brake hydraulic pressure if bottoming of the second master piston occurs in the vehicle hydraulic brake device of FIG. 2;

FIG. 8B is a graph showing change in the relation between the output hydraulic pressure of the pressure adjusting valve and the second brake hydraulic pressure if bottoming of the first master piston occurs in the vehicle hydraulic brake device of FIG. 2;

FIG. 9A is a graph similar to FIG. 8A if bottoming of the second master piston occurs in the vehicle hydraulic brake device of FIG. 3;

FIG. 9B is a graph similar to FIG. 8B if bottoming of the first master piston occurs in the vehicle hydraulic brake device of FIG. 3;

FIG. 10A is a view showing change in the relation between the first brake hydraulic pressure and the second brake hydraulic pressure if bottoming of the second master piston occurs in the vehicle hydraulic brake device of FIG. 4; and

FIG. 10B is a view showing change in the relation between the first brake hydraulic pressure and the second brake hydraulic pressure if bottoming of the first master piston occurs in the vehicle hydraulic brake device of FIG. 4.

### DETAILED DESCRIPTION OF THE PREFERRED EMBODIMENT

The vehicle hydraulic brake device embodying the present invention will be described with reference to the accompanying drawings.

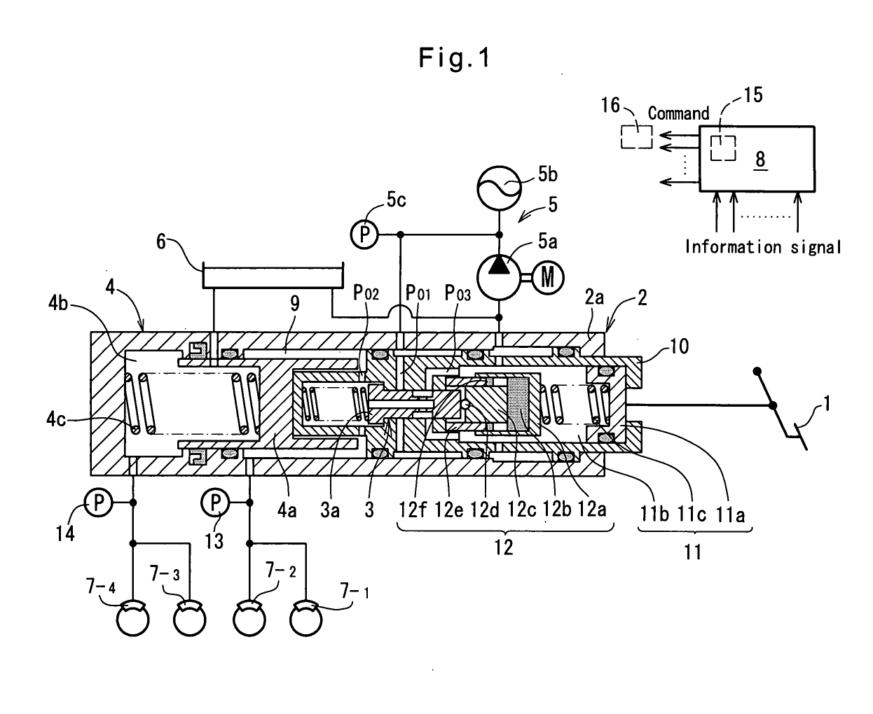

In FIG. 1, it includes a brake pedal 1, a pressure adjusting device 2 which is a combination of a pressure adjusting valve 3 and a master cylinder 4 and has a boosting function, a hydraulic pressure source 5 including a power driven pump 5a, an accumulator 5b for accumulating hydraulic pressure generated by the pump 5a, and a hydraulic pressure sensor 5c, an atmospheric reservoir 6 communicating with the inlet ports of the pump 5a and the master cylinder 4, wheel cylinders 7-1 to 7-4 for imparting braking force to the respective vehicle wheels, and an electronic control unit (ECU) 8. In the hydraulic pressure source 5, when the hydraulic pressure detected by the hydraulic pressure sensor 5c reaches a preset lower limit, a command is given from the electronic control unit 8, which receives a signal from the hydraulic pressure sensor 5c, to actuate the pump 5a. When the detected hydraulic pressure reaches a preset upper limit, the pump 5a will stop. Thus, in a normal state, it always accumulates a predetermined hydraulic pressure.

In the pressure adjusting device 2, the output hydraulic pressure of the pressure adjusting valve 3 is introduced into a pressure chamber 9 to actuate the master cylinder 4 under the hydraulic pressure.

The pressure adjusting device 2 is provided with an auxiliary piston 10 in a housing 2a, and transmits the brake operating force applied to the brake pedal 1 to the pressure adjusting valve 3 through a stroke simulator 11 and a distribution device 12 built in the auxiliary piston 10.

The stroke simulator 11 comprises a simulator piston 11a to which brake operating force is applied from the brake pedal 1, and an elastic member 11c arranged in a simulator chamber 11b, which is under the atmospheric pressure, and adapted to impart a stroke proportional to the brake operating force to the simulator piston 11a and transmit the brake operating force to the distribution device 12.

The distribution device 12 comprises a cup-like member 12a, a rubber member 12b mounted in the member 12a, a transmission member 12c and a steel ball 12d that are disposed between the rubber member 12b and the pressure adjusting valve 3, and a tubular member 12e having one end thereof in abutment with the auxiliary piston 10 and the other end inserted in the cup-like member 12a. (To the tip of the member 12e, a resin annular plate 12f is mounted to protect the rubber member 12b, which is elastically deformed and gets into a gap between the cup-like member 12a and the transmission member 12c during brake operation.)

By providing the distribution device 12, in the initial stage of braking, the brake operating force applied to the cup-like member 12a is transmitted to the pressure adjusting valve 3 as it is. But, when the brake operating force exceeds a certain value, the rubber member 12b, which has elastically deformed and gotten into the gap between the cup-like member 12a and the transmission member 12c, will abut the resin annular plate 12f. Thereafter, only part of the brake operating force is transmitted to the pressure adjusting valve 3. Thus, using this function, it is possible to impart to the brake device jumping properties which make steep the initial uprise of the brake hydraulic pressure adjusted by the pressure adjusting valve 3 (that is, output hydraulic pressure of the pressure adjusting valve). Also, it is possible to change the relation between the brake operating force and the output hydraulic pressure of the pressure adjusting valve by replacing the rubber member 12b with one having different properties and/or size. But the distribution device 12 is not an essential but preferable element.

The auxiliary piston 10 has an input port P01, output port P02 and pressure reduction port P03 with the input port P01 connected to the hydraulic pressure source 5 through a fluid chamber formed on the outer periphery of the auxiliary piston 10, the output port P02 connected to the wheel cylinders 7-1 and 7-2 through the pressure chamber 9, and the pressure reduction port P03 to the atmospheric reservoir 6 through the simulator chamber 11b and the fluid chamber formed on the outer periphery of the auxiliary piston 10. The changeover of connection of the output port P02 to the input port P01 and the pressure reduction port P03, separation of the output port P02 from the input port P01 and the pressure reduction port P03, and the degree of opening of the valve portion are performed by displacing the spool 3a.

The pressure adjusting valve 3, which adjusts the hydraulic pressure supplied from the hydraulic pressure source 5 to a value proportional to the brake operating amount by the displacement of the spool 3a and outputs it, is well known. Thus its detailed description is omitted.

The output hydraulic pressure of the pressure adjusting valve 3 is introduced through the output port P02 into the pressure chamber 9, and under this hydraulic pressure, the master piston 4a advances compressing the return spring 4c to generate brake hydraulic pressure corresponding to the brake operating amount in the master hydraulic chamber 4b.

To the wheel cylinders 7-1 and 7-2, which are in a first hydraulic line, the output hydraulic pressure of the pressure adjusting valve 3 is supplied. Hydraulic pressure generated in the master cylinder 4 is supplied to the wheel cylinders 7-3 and 7-4, which are in a second hydraulic line.

While this hydraulic brake device for a vehicle is operating normally and the output hydraulic pressure of the pressure adjusting valve 3 is being introduced into the pressure chamber 9, it is held in the illustrated position with the auxiliary piston 10 acted by the hydraulic pressure introduced into the pressure chamber 9. If hydraulic pressure is not introduced when it should be introduced, the auxiliary piston 10 will be pushed leftwardly in FIG. 1 by the brake operating force, so that the brake operating force is directly transmitted to the master piston 4a through the auxiliary piston 10. Thus, even if the hydraulic pressure source 5 fails, at least the master cylinder pressure obtained manually will be ensured. Thus minimum necessary braking force is ensured.

In FIG. 1, there are shown a pressure sensor 13 for detecting the output hydraulic pressure of the pressure adjusting valve 3, and a master cylinder pressure sensor 14 for detecting the output hydraulic pressure of the master cylinder 4. In the vehicle hydraulic brake device of FIG. 1, the output hydraulic pressure of the pressure adjusting valve detected by the pressure sensor 13 is compared with the output hydraulic pressure of the master cylinder 4 detected by the master cylinder pressure sensor 14 by the bottoming detecting means 15.

The bottoming detecting means 15 is an electrical comparator/determination circuit having an alarm means 16, and determines that bottoming has developed if the output hydraulic pressure of the master cylinder gets out of a predetermined relation, and activates the alarm means 16.

The alarm means 16 may be an ordinary alarm device that notifies abnormality visually or audibly.

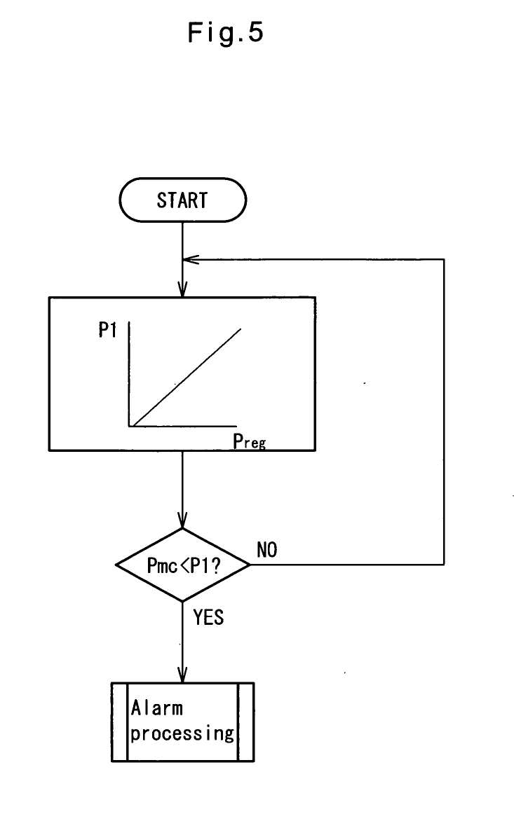

FIG. 5 shows a flowchart for bottoming detection in the vehicle hydraulic brake device of FIG. 1. Data which serve as basis for judgment of bottoming detection (relation between the output hydraulic pressure of the pressure adjusting valve 3 and that of the master cylinder 4) are input beforehand into the bottoming detecting means. The output hydraulic pressure Preg of the pressure adjusting valve 3 detected by the pressure sensor 13 is compared with the output hydraulic pressure Pmc of the master cylinder 4 detected by the master cylinder pressure sensor 14, and if the output hydraulic pressure Pmc of the master cylinder 4 is smaller than a predetermined pressure P1 (condition Pmc<P1 met), it is determined that bottoming of the master piston 4a has occurred and alarming is performed. If the condition Pmc<P1 is not met, it returns to the START and repeats the above comparison/determination.

Here, the output hydraulic pressure of the pressure adjusting valve 3 is regarded as the brake operating amount, and compared with the output hydraulic pressure of the master cylinder 4. But for example, the stroke of a brake operating member such as the brake pedal 1 or the brake operating force applied to the brake pedal may be detected and compared with the output hydraulic pressure of the master cylinder.

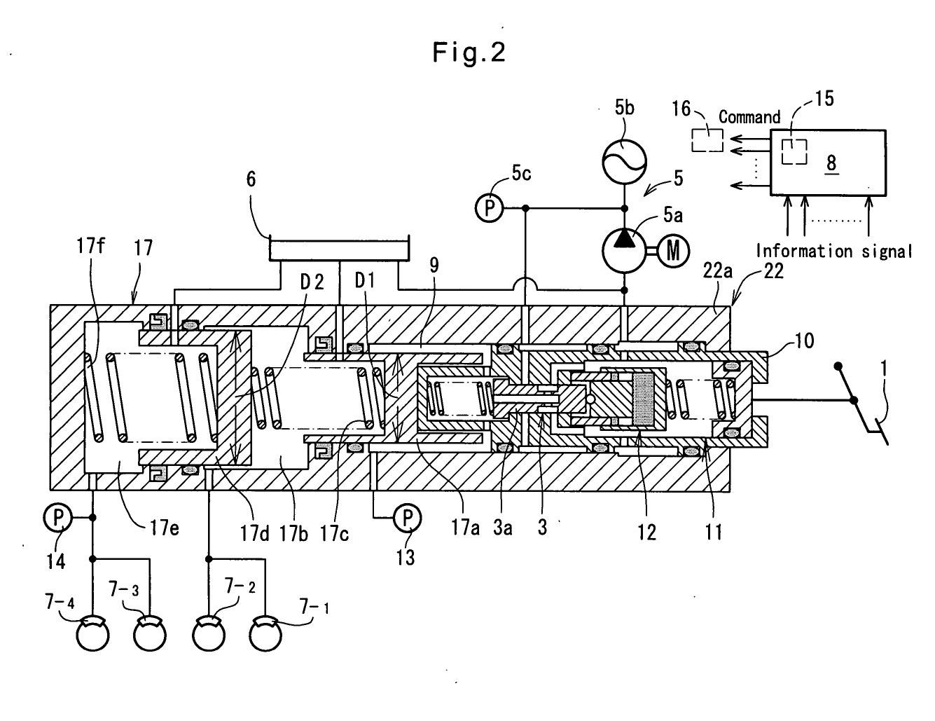

FIG. 2 shows an example in which this invention has been applied to a vehicle hydraulic brake device provided with a tandem master cylinder 17.

The brake pedal 1, hydraulic pressure source 5 having a power driven pump, atmospheric reservoir 6, wheel cylinders 7-1 to 7-4, electronic control unit 8, auxiliary piston 10 provided in the housing 22a of the pressure adjusting device 22, stroke simulator 11, distribution device 12 and pressure adjusting valve 3 are the same as those provided in the vehicle hydraulic brake device of FIG. 1. Thus, identical numerals are used for them and description is omitted.

The tandem master cylinder 17 includes a first master piston 17a actuated under the output hydraulic pressure of the pressure adjusting valve 3, which is introduced into a pressure chamber 9, a first master hydraulic chamber 17b in which a first brake hydraulic pressure is generated by pressurizing brake fluid with the first master piston 17a, a return spring 17c for the first master piston 17a, a second master piston 17d actuated under the first brake hydraulic pressure generated in the first master hydraulic chamber 17b, a second master hydraulic chamber 17e in which a second brake hydraulic pressure is generated by pressurizing brake fluid with the second master piston 17d, and a return spring 17f for the second master piston to supply the first brake hydraulic pressure, which is generated in the first master hydraulic chamber 17b, to the wheel cylinders 7-1 and 7-2, which are in the first hydraulic line, and supply the second brake hydraulic pressure, which is generated in the second master hydraulic chamber 17e to the wheel cylinders 7-3 and 7-4, which are in the second hydraulic line.

In the vehicle hydraulic brake device of FIG. 2, the effective diameter D1 (output diameter) of the first master piston 17a is smaller than the effective diameter D2 of the second master piston 17d, the output hydraulic pressure Preg of the pressure adjusting valve 3 detected by the pressure sensor 13 is compared with the second brake hydraulic pressure Pmc2 detected by the master cylinder pressure sensor 14 by the bottoming detecting means 15. If the second brake hydraulic pressure Pmc2 is smaller than a predetermined pressure P1 (condition Pmc2<P1 met), it is determined that bottoming of the first master piston 17a or second master piston 17d occurred and alarm is given. If the condition Pmc2<P1 is not met, it returns to start and the above comparison/determination is repeated.

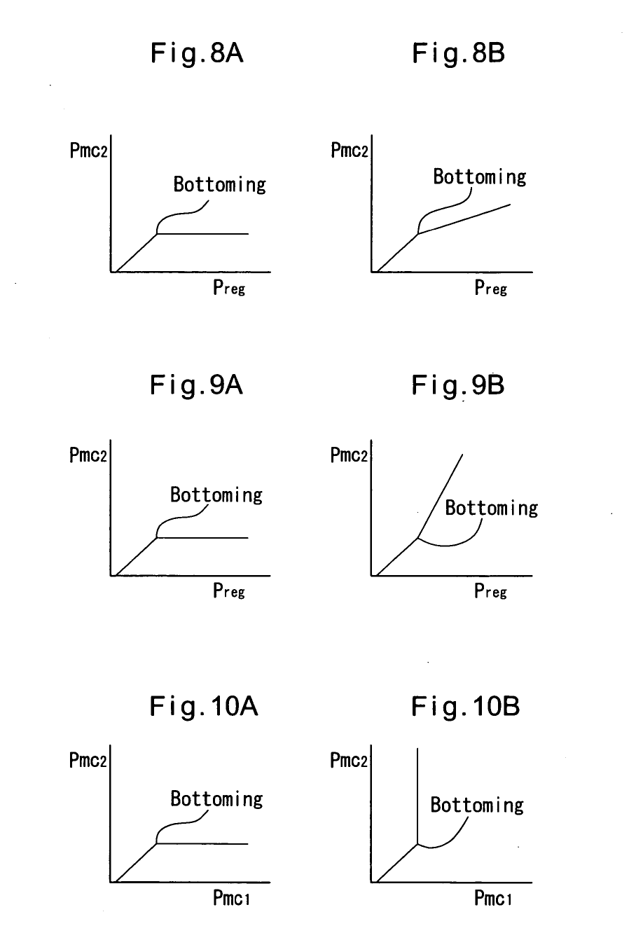

In the vehicle hydraulic brake device of FIG. 2, too, by replacing Pmc in the flowchart of FIG. 5 with Pmc2, bottoming detection can be made. Since the effective diameter D1 of the first master piston 17a is smaller than the effective diameter D2 of the second master piston 17d, if bottoming of the second master piston 17d occurs, as shown in FIG. 8A, in the relation between the output hydraulic pressure Preg of the pressure adjusting valve 3 and the second brake hydraulic pressure Pmc2, the second brake hydraulic pressure Pmc2 will be relatively lower than the target line. Also, if bottoming of the first master piston 17a occurs, as shown in FIG. 8b, in the relation between the output hydraulic pressure Preg of the pressure adjusting valve 3 and the second brake hydraulic pressure Pmc2, the second brake hydraulic pressure Pmc2 will be relatively lower than the target line. Thus, by replacing Pmc in the flowchart of FIG. 5 with Pmc2, even if bottoming of the first master piston 17a occurs, or bottoming of the second master piston 17d occurs, condition Pmc2<P1 is met, so that it is possible to detect bottoming.

Since the state of change in the second brake hydraulic pressure Pmc2 if bottoming of the first master piston 17a occurs differs from the state of change if bottoming of the second master piston 17d occurs, if necessary, it is possible to determine whether bottoming of the first master piston 17a has occurred or bottoming of the second master piston 17d has occurred.

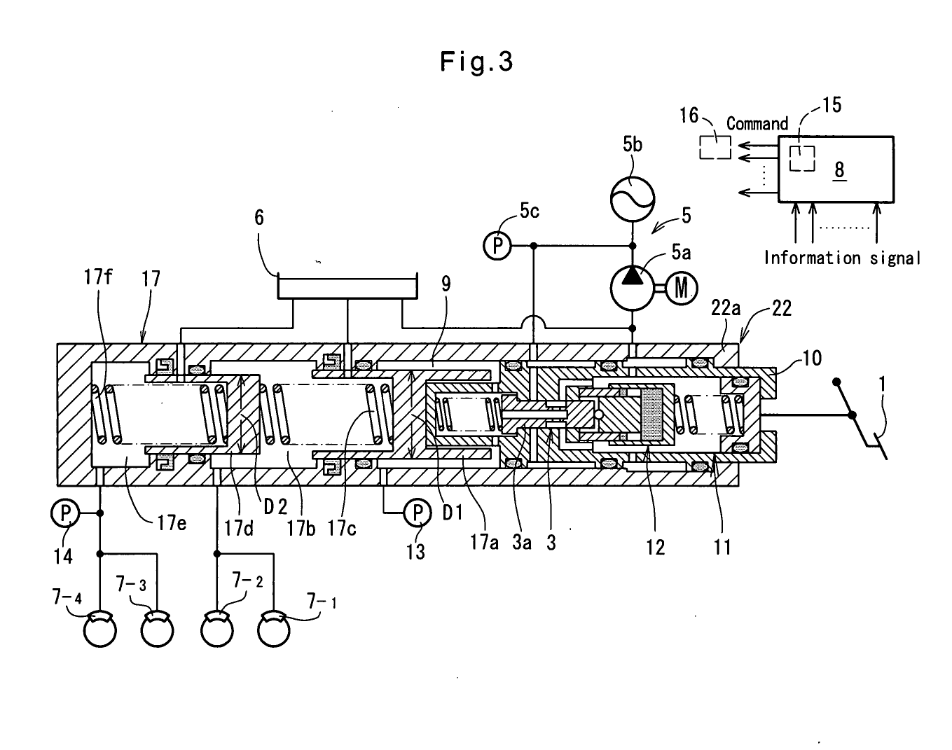

FIG. 3 shows a third embodiment. The vehicle hydraulic brake device of FIG. 3 also uses a tandem master cylinder 17. But the effective diameter D1 of the first master piston 17a is greater than the effective diameter D2 of the second master piston 17d. This is a difference from the vehicle hydraulic brake device of FIG. 2.

In the vehicle hydraulic brake device of FIG. 3, since the effective diameter D1 of the first master piston 17a is greater than the effective diameter D2 of the second master piston 17d, if bottoming of the second master piston 17d occurs, as shown in FIG. 9A, in the relation between the output hydraulic pressure Preg of the pressure adjusting valve 3 and the second brake hydraulic pressure Pmc2, the second brake hydraulic pressure Pmc2 will be relatively lower than the target line. If bottoming of the first master piston 17a occurs, as shown in FIG. 9B, in the relation between the output hydraulic pressure Preg of the pressure adjusting valve 3 and the second brake hydraulic pressure Pmc2, the second brake hydraulic pressure Pmc2 will be relatively higher than the target line.

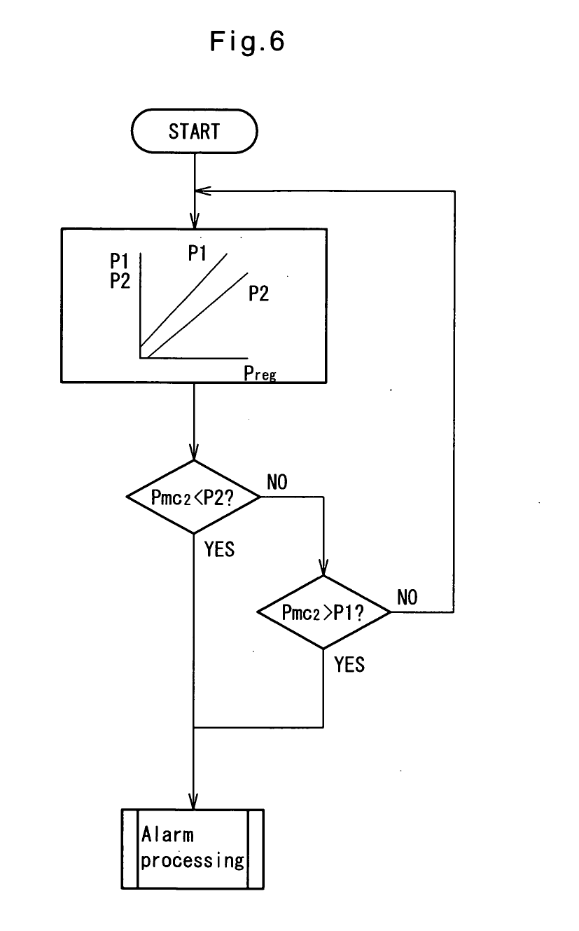

Thus, a flowchart as shown in FIG. 6 is used. The upper limit threshold value P1 and the lower limit threshold value P2 in the relation between the output hydraulic pressure of the pressure adjusting valve 3 and the second brake hydraulic pressure are preset in the bottoming detecting means 15 beforehand to compare the output hydraulic pressure Preg of the pressure adjusting valve 3 detected by the pressure sensor 13 with the second brake hydraulic pressure Pmc2 detected by the master cylinder pressure sensor 14. If the second brake hydraulic pressure Pmc2 is smaller than the lower limit threshold value P2 (Condition Pmc2<P1 met), it is determined that bottoming of the second master piston 17d occurred and an alarm is given. If the condition is not met, it proceeds to the next step to determine whether or not the second brake hydraulic pressure Pmcs is greater than the upper limit threshold value P1 (condition Pmc2>P1 met). If affirmative, it is determined that bottoming of the first master piston 17a occurred and an alarm is given. If negative, it returns to START, and the above comparison/determination is repeated. The flowchart of FIG. 6, too, is a mere example.

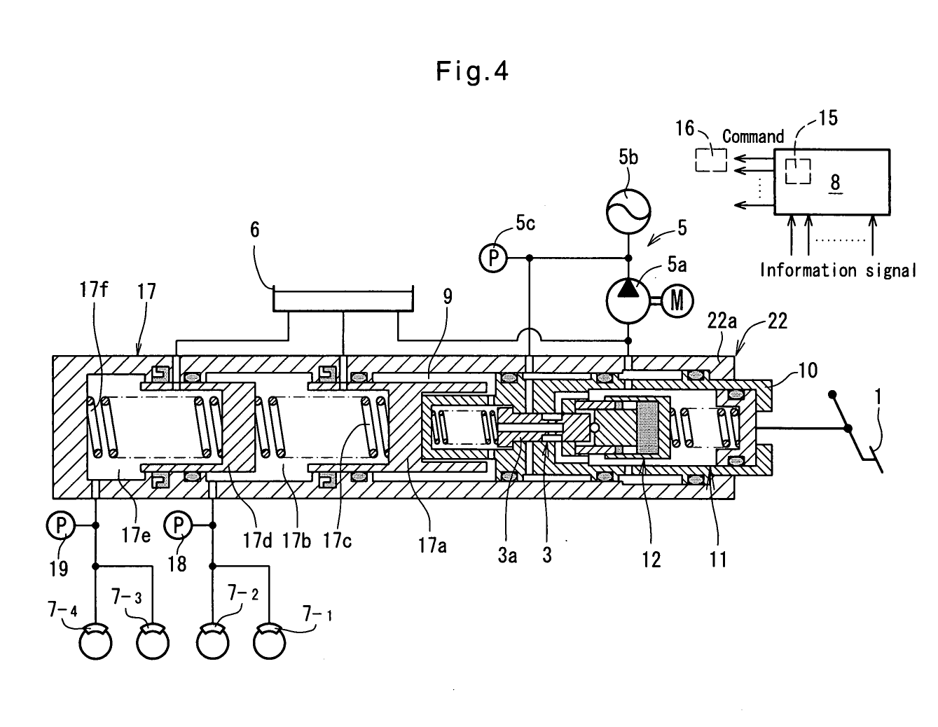

FIG. 4 shows the fourth embodiment. The vehicle hydraulic brake device of FIG. 4 has a tandem master cylinder 17 in which the effective diameters of the first master piston 17a and the second master piston 17d are equal to each other.

The brake pedal 1, hydraulic pressure source 5, atmospheric reservoir 6, wheel cylinders 7-1 to 7-4, electronic control unit 8, auxiliary piston 10 provided in the housing 22a of the pressure adjusting device 22, stroke simulator 11, distribution device 12 and pressure adjusting valve 3 are the same as those provided in the vehicle hydraulic brake devices of FIGS. 2 and 3. Thus, identical numerals are used and description is omitted.

In the vehicle hydraulic brake device of FIG. 4, first brake hydraulic pressure generated by a first master piston 17a is detected by a first master cylinder pressure sensor 18, second brake hydraulic pressure generated by a second master piston 17d is detected by a second master cylinder pressure sensor 19, and the first brake hydraulic pressure is compared with the second brake hydraulic pressure by the bottoming detecting means 15 to detect that bottoming of the first master piston 17a or the second master piston 17d has occurred.

As shown in FIG. 10A, if bottoming of the second master piston 17d occurs, in the relation between the first brake hydraulic pressure Pmc1 and the second brake hydraulic pressure Pmc2, the second brake hydraulic pressure Pmc2 will be relatively lower than the target line. On the other hand, if bottoming of the first master piston 17a occurs, as shown in FIG. 10B, in the relation between the first brake hydraulic pressure Pmc1 and the second brake hydraulic pressure Pmc2, the second brake hydraulic pressure Pmc2 will be relatively higher than the target line. Thus, by monitoring whether the first brake hydraulic pressure Pmc1 and the second brake hydraulic pressure Pmc2 are in the range which satisfies a predetermined relation, it is possible to detect that bottoming of the first master piston 17a or the second master piston 17d has occurred.

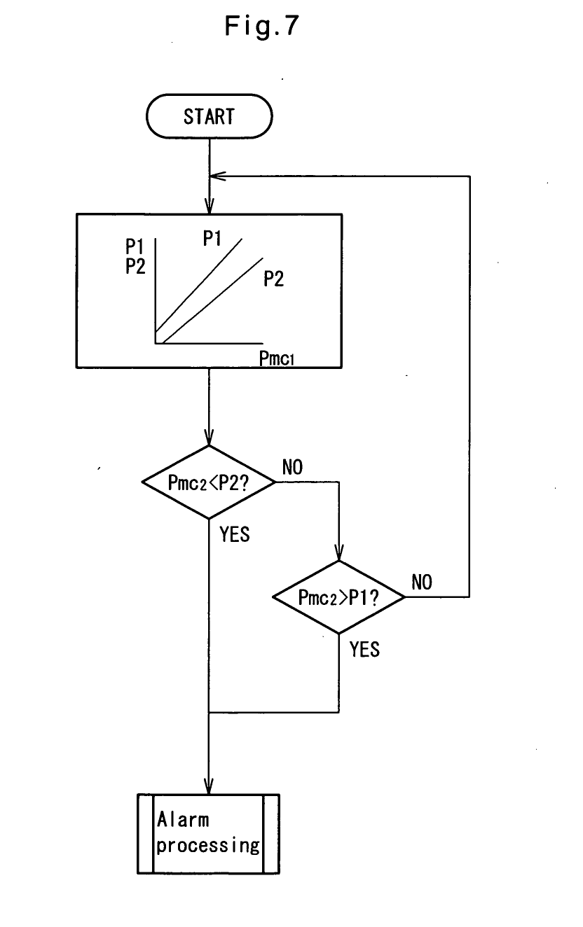

FIG. 7 is an example of a flowchart for bottoming detection in the vehicle hydraulic brake device of FIG. 4. In this case, as data for judgment for bottoming detection, the upper limit threshold value P1 and the lower limit threshold value P2 in the relation between the first brake hydraulic pressure and the second brake hydraulic pressure are preset and input in the bottoming detecting means 15 beforehand to compare the first brake hydraulic pressure Pmc1 detected by the first master cylinder pressure sensor 18 with the second brake hydraulic pressure Pmc2 detected by the second master cylinder pressure sensor 19. And if the second brake hydraulic pressure Pmc2 is smaller than the lower limit threshold value P2 (Condition Pmc2<P2 met), it is determined that bottoming of the second master piston 17d has occurred and an alarm is given. If this condition is not met, it proceeds to the next step to determine whether the second brake hydraulic pressure Pmc2 is greater than the upper limit threshold value P1 (condition Pmc2>P1 met). If affirmative, it is determined that bottoming of the first master piston 17a has occurred and an alarm is given. If negative, it returns to START and the above comparison/determination is repeated.

In any of the vehicle hydraulic brake devices of the embodiments, if bottoming of the master piston occurs due to vapor lock phenomenon, the alarm means 16 is activated. Thus the driver can recognize this fact before the braking force drops and stop the vehicle.

As described above, since the vehicle hydraulic brake device of this invention can detect bottoming of the master piston and inform the driver of this fact, the driver can stop the vehicle before the braking force begins to decrease.

Also since the bottoming of the master cylinder is detected by comparing the brake operating amount with the output hydraulic pressure of the master cylinder, comparing the brake operating amount with the second brake hydraulic pressure generated in the tandem master cylinder, or comparing the first brake hydraulic pressure generated in the tandem master cylinder with the second brake hydraulic pressure, it is not necessary to detect the stroke of the master piston directly. Thus the limitation of installation from the viewpoint of space is relaxed and also the cost increase of the vehicle hydraulic brake device is suppressed.

What is claimed is:

1. A vehicle hydraulic brake device comprising a hydraulic pressure source for generating a predetermined hydraulic pressure, a pressure adjusting valve for adjusting the output hydraulic pressure of said hydraulic pressure source to a value proportional to a brake operating amount, a pressure chamber, a master cylinder having a master piston actuated under the output hydraulic pressure of said pressure adjusting valve introduced into said pressure chamber for generating brake hydraulic pressure, and wheel cylinders actuated under the output hydraulic pressure from said master cylinder for generating braking force to wheels of the vehicle, further comprising a brake operating amount detecting means for detecting the brake operating amount, a master cylinder pressure detecting means for detecting the output hydraulic pressure of said master cylinder, and a bottoming detecting means for detecting the bottoming of said master piston by comparing the brake operating amount detected by said brake operating amount detecting means with the output hydraulic pressure of said master cylinder detected by said master cylinder pressure detecting means.

2. A vehicle hydraulic brake device comprising a hydraulic pressure source for generating a predetermined hydraulic pressure, a pressure adjusting valve for adjusting the output hydraulic pressure of said hydraulic pressure source to a value proportional to a brake operating amount, a pressure chamber, a tandem master cylinder having a first master piston actuated under the output hydraulic pressure of said pressure adjusting valve introduced into said pressure chamber to generate a first brake hydraulic pressure, and having a second master piston actuated under the first brake hydraulic pressure to generate a second brake hydraulic pressure, and wheel cylinders actuated under the first brake hydraulic pressure and the second brake hydraulic pressure for imparting braking force to wheels of the vehicle,
said first master piston and said second master piston having different effective diameters, and further comprising a brake operating amount detecting means for detecting the brake operating amount, a master cylinder pressure detecting means for detecting the second brake hydraulic pressure generated by said tandem master cylinder, and a bottoming detecting means for detecting the bottoming of said first master piston or said second master piston by comparing the brake operating amount detected by said brake operating amount detecting means with the second brake hydraulic pressure detected by said master cylinder pressure detecting means.

3. A vehicle hydraulic brake device as claimed in claim 1 wherein the brake operating amount detected by said brake operating amount detecting means is a stroke of a brake operating member.

4. A vehicle hydraulic brake device as claimed in claim 2 wherein the brake operating amount detected by said brake operating amount detecting means is a stroke of a brake operating member.

5. A vehicle hydraulic brake device as claimed in claim 1 wherein the brake operating amount detected by said brake operating amount detecting means is a brake operating force applied to a brake operating member.

6. A vehicle hydraulic brake device as claimed in claim 2 wherein the brake operating amount detected by said brake operating amount detecting means is a brake operating force applied to a brake operating member.

7. A vehicle hydraulic brake device as claimed in claim 1 wherein the brake operating amount detected by said brake operating amount detecting means is the output hydraulic pressure of said pressure adjusting valve, which is relevant to the brake operating amount.

8. A vehicle hydraulic brake device as claimed in claim 2 wherein the brake operating amount detected by said brake operating amount detecting means is the output hydraulic pressure of said pressure adjusting valve, which is relevant to the brake operating amount.

9. A vehicle hydraulic brake device comprising a hydraulic pressure source for generating a predetermined hydraulic pressure, a pressure adjusting valve for adjusting the output hydraulic pressure of said hydraulic pressure source to a value proportional to a brake operating amount, a pressure chamber, a tandem master cylinder having a first master piston actuated under the output hydraulic pressure of said pressure adjusting valve introduced into said pressure chamber to generate a first brake hydraulic pressure, and having a second master piston actuated under the first brake hydraulic pressure to generate a second brake hydraulic pressure, and wheel cylinders actuated under the first brake hydraulic pressure and the second brake hydraulic pressure for imparting braking force to wheels of the vehicle, further comprising a first master cylinder pressure detecting means and a second master cylinder pressure detecting means for detecting the first brake hydraulic pressure and the second brake hydraulic pressure, respectively, which said tandem master cylinder outputs, and a bottoming detecting means for detecting the bottoming of said first master piston or said second master piston by comparing the first brake hydraulic pressure detected by said first master cylinder pressure detecting means with the second brake hydraulic pressure detected by said second master cylinder pressure detecting means.

10. A vehicle hydraulic brake device as claimed in claim 1 wherein said bottoming detecting means comprises an alarm means for producing an alarm if bottoming of said master piston is detected.

11. A vehicle hydraulic brake device as claimed in claim 2 wherein said bottoming detecting means comprises an alarm means for producing an alarm if bottoming of said master piston is detected.

12. A vehicle hydraulic brake device as claimed in claim 9 wherein said bottoming detecting means comprises an alarm means for producing an alarm if bottoming of said master piston is detected.
